(19) United States
(12) Patent Application Publication
(10) Pub. No.: US 2026/0328551 A1
(43) Pub. Date: Oct. 22, 2026

(54) BUMP BOARD

(71) Applicant: AOB Products Company, Columbia, MO (US)

(72) Inventors: Mark Dalton, Columbia, MO (US); Russell Bergeron, Columbia, MO (US); Dennis Cauley, Fayette, MO (US); Timothy S. Kinney, Warrenton, MO (US)

(73) Assignee: AOB Products Company, Columbia, MO (US)

(21) Appl. No.: 19/647,436

(22) Filed: Apr. 14, 2026

Related U.S. Application Data
(60) Provisional application No. 63/789,575, filed on Apr. 16, 2025.

(51) Int. Cl. G01B 3/04

(52) U.S. Cl. CPC G01B 3/04

(57) ABSTRACT

A measuring device or bump board, associated components and methods. The measuring device measures a length of an object. The measuring device includes an object support and a reference. The object support has a support surface to receive and support the object. The object support has ruler indicia extending along the support surface. The reference is coupled to the object support. The reference is contacted by one end of the object when the object is on the support surface of the object support. The ruler indicia indicates distance from the reference. An anti-tamper feature visually indicate if a length of the object support has been altered. A identification holder supports an identifier. The identification holder is supported by and moveable along the object support.

### CROSS-REFERENCE TO RELATED APPLICATION

This application claims priority to U.S. Provisional Patent Application No. 63/789,575, filed Apr. 16, 2025, the entirety of which is hereby incorporated by reference.

### FIELD

The present disclosure relates to measuring devices for measuring the length of an object, and more particularly to a fish measuring device for measuring the length of the fish.

### BACKGROUND

People (such as fishermen and women) use measuring devices (e.g., ruler tape) to measure the length of a caught fish. One such measuring device people use is a bump board (also bumpboard).

### SUMMARY

In one aspect, a measuring device for measuring a length of an object comprises an object support having a support surface configured to receive and support the object thereon. The object support has ruler indicia extending along the support surface. A reference is coupled to the object support. The reference is arranged to be contacted by one end of the object when the object is on the support surface of the object support. The ruler indicia of the object support indicates distance from the reference. An anti-tamper feature is configured to visually indicate if a length of the object support has been altered.

In another aspect, a measuring device for measuring a length of an object comprises an object support having a support surface configured to receive and support the object thereon. The object support has ruler indicia extending along the support surface. A reference is coupled to the object support. The reference is arranged to be contacted by one end of the object when the object is on the support surface of the object support. The ruler indicia of the object support indicates a distance from the reference. An identification holder is configured to support an identifier. The identification holder is supported by and moveable along the object support.

Other objects and features of the present disclosure will be in part apparent and in part pointed out herein.

### BRIEF DESCRIPTION OF THE DRAWINGS

FIG. 1 is a perspective of a measuring device according to one embodiment of the present disclosure;

FIG. 2 is another perspective of the measuring device;

FIG. 3 is an end elevation view of the measuring device;

FIG. 4 is an elevation view of an end wall of the measuring device;

FIG. 5 is an enlarged, fragmentary perspective of the measuring device;

FIG. 6 is a cross-sectional view of the measuring device;

FIG. 7 is a perspective of an identification holder of the measuring device; and

FIG. 8 is an illustration of the identification holder.

Corresponding reference characters indicate corresponding parts throughout the drawings.

### DETAILED DESCRIPTION

The present disclosure is for a measuring device for measuring the length of an object, such as a fish. The measuring device includes an object support assembly having a ruler allowing a user or operator to visually determine the length of the object. The measuring device includes anti-tamper features to visually indicate if a length of the object support has been altered, such as to a person or tournament official. The measuring device also includes an identification holder for support an identifier. The measuring device of the present disclosure is particularly suitable for measuring the length of a fish, although it is understood the measuring device can be used to measure the lengths of other objects without departing from the scope of the present disclosure.

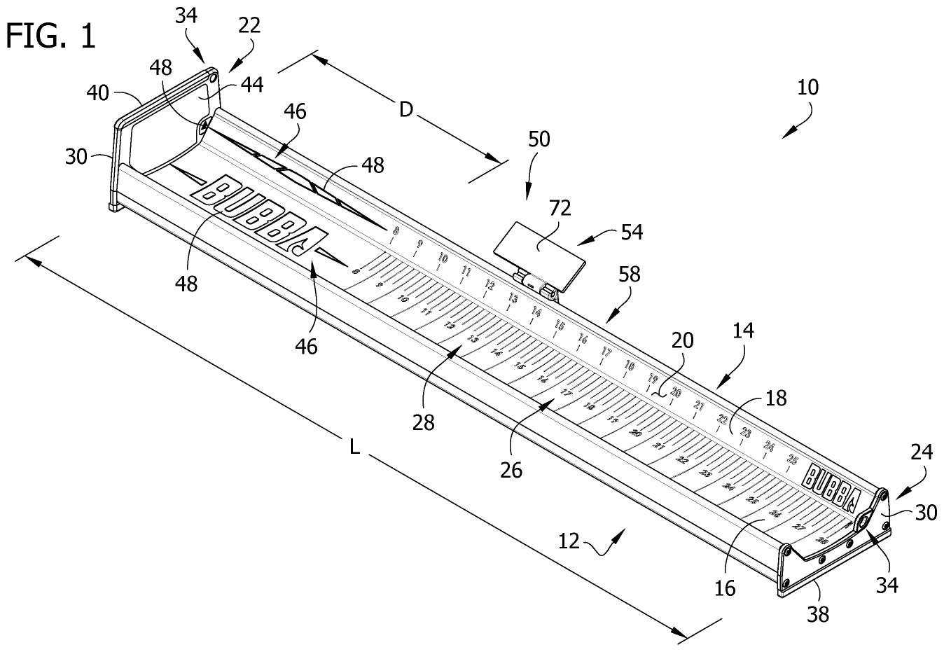

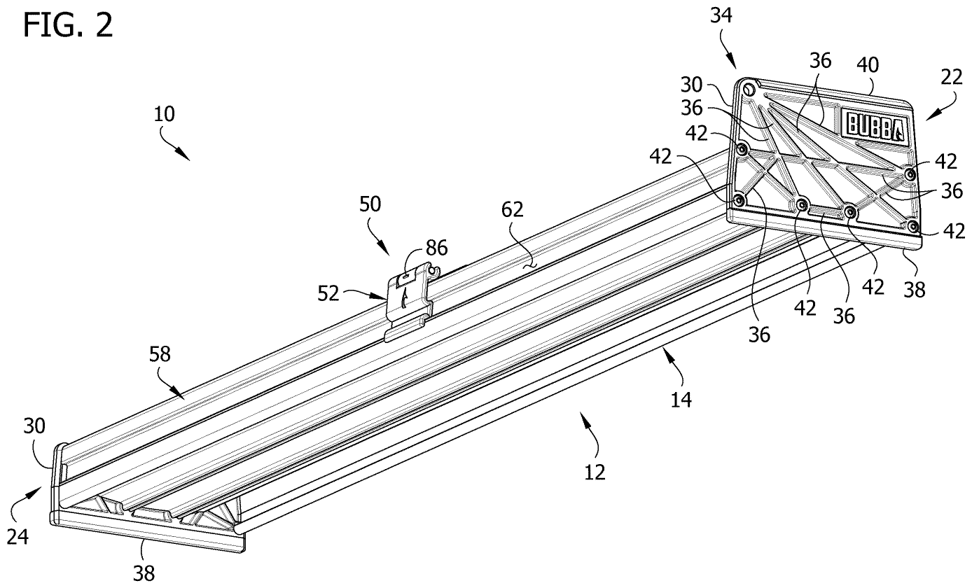

Referring to FIGS. 1 and 2, a measuring device (e.g., a fish measuring device, bump board, or bumpboard) according to one embodiment of the present disclosure is generally indicated a reference numeral 10. The measuring device 10 includes an object support assembly 12. The object support assembly 12 includes an object support, platform, or tray 14 that receives and supports an object, such as a fish, along the length of the object. The object support 14 has opposite first and second ends. The object support extends linearly between the first and second ends along an axis. The object support 14 can be made of metal (e.g., steel, aluminum, etc.), plastic, or any other suitable material. In one embodiment, the object support 14 is an extruded component (e.g., aluminum extrusion) and has a uniform cross section over its length. As such, the object support 14 is a single, integrally formed, one-piece component. In other embodiments, the object support can be made of multiple pieces connected together.

The object support 14 includes a support surface 16 that receives and supports the object thereon. The support surface 16 generally faces upward, and can be flat or curved. In the illustrated embodiment, the object support 14 defines a cradle that includes (e.g., forms or bounds) an object receiving channel, recess, or space 20. The object receiving channel 20 is sized and shaped to receive at least a portion of the object whose length is being measured. The object receiving channel 20 extends along the length of the object support 14. The support surface 16 bounds the bottom of the object receiving channel 20. In the illustrated embodiment, the object support 14 includes side surfaces 18 (e.g., inner side surfaces) that generally face each other and bound opposite sides of the object receiving channel 20. The side surfaces 18 prevent the object from moving sideways off the object support 14. Other configurations of the object support can be used without departing from the scope of the present disclosure.

The object support assembly 12 (broadly, the measuring device 10) includes a reference or stop 22. The reference 22 is coupled to the object support 14. The reference 22 is connected to the first end of the object support. The reference 22 is engaged by the object being measured. The reference 22 is arranged to be contacted by one end of the object when the object is on the support surface 16 of the object support 14. The reference 22 forms a closed end of the object receiving channel 20. In the illustrated embodiment, the reference 22 is a wall (e.g., a first end wall). Other configurations of the reference can be used without departing from the scope of the present disclosure.

The measuring device 10 includes a ruler 26 that is visually referenced by the user to determine the length of the object. The ruler 26 extends along the length (e.g., axis) of the object support 14. The ruler 26 includes ruler indicia 28 for visually indicating the length (e.g., a length value), such as 10.5 inches, of the object. The ruler indicia 28 comprises ruler markings, graduations, or lines at fixed increments (e.g., ¼ inch increments) along object support and corresponding ruler values (e.g., “8,” “9,” “10,” etc.) that are in units of distance (e.g., mm, cm, inches, feet, etc.). The ruler 26 (e.g., ruler indicia 28) measures or indicates distance from the reference 22. For example, in the illustrated embodiment the ruler values are in inches, such that the illustrated ruler value “9” and associated ruler marking indicate a distance of 9-inches from the reference 22.

In the illustrated embodiment, the object support 14 includes the ruler 26. The ruler indicia 28 is a fixed part of the object support 14. The ruler 26 is arranged to be viewed by a user or person looking generally downward at the measuring device 10 from above. The ruler indicia 28 is disposed on and extends along the support surface 16 and/or one or both of the side surfaces 18. In the illustrated embodiment, the ruler indicia 28 is disposed on the support surface 16 and at least one of the side surfaces 18. The ruler indicia 28 can be an integral part of the object support 14 (e.g., injection molded with the object support, laser etched on the object support, etc.) or can be added to the object support (e.g., painted on the object support, sticker(s) applied on the object support, etc.).

In the illustrated embodiment, the start of the ruler 26 (the start of the ruler indicia 28 or the ruler indicia associated with the lowest length value (e.g., “8” as illustrated) indicated by the ruler) is spaced apart from the reference 22 (e. g, contact surface thereof) by a distance D. In other words, the ruler 28 (the ruler indicia 28) only measures the length of objects that have a length greater than a minimum length. In one embodiment, the distance D between the start of the ruler 26 (e.g., ruler indicia 28) and the reference 22 is greater than or equal to 1-inch , or greater than or equal to 5-inches, or greater than or equal to 8-inches. In the illustrated embodiment, the ruler 26 (e.g., the ruler indicia) starts at 8-inches (the distance D is 8 inches), although the ruler can start at a different value without departing from the scope of the present disclosure. This means the object being measured by the illustrated measuring device 10 needs to have a minimum length of 8 inches in order for the ruler 26 (ruler indicia 28) (broadly, the measurement device 10) to visually indicate the length (e.g., length value) of the object. Other configurations of the ruler can be used without departing from the scope of the present disclosure.

In use, the user places the object (e.g., fish) on the support surface 16 of the object support 14 and engages one end of the object with the reference 22. After, the user identifies which ruler indicia 28 the opposite end of the object aligns with or most closely aligns with (e.g., where the opposite end of the object lands on the ruler 26), thereby visually telling the user the length (e.g., length value) of the object.

The object support assembly 12 (broadly, the measuring device 10) can include an end wall 24 (e.g., a second end wall). The second end wall 24 is connected to the second end of the object support 14 (opposite the reference 22). In the illustrated embodiment, the second end wall 24 (specifically, an upper edge thereof) generally matches or follows the shape or contour of the object support 14 such that the opposite end of the object receiving channel 20 is open.

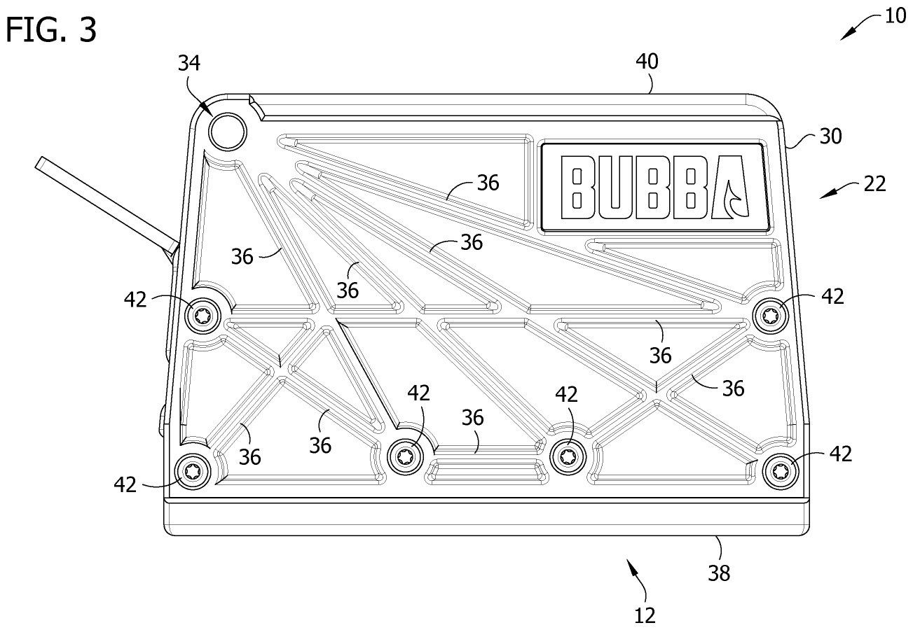

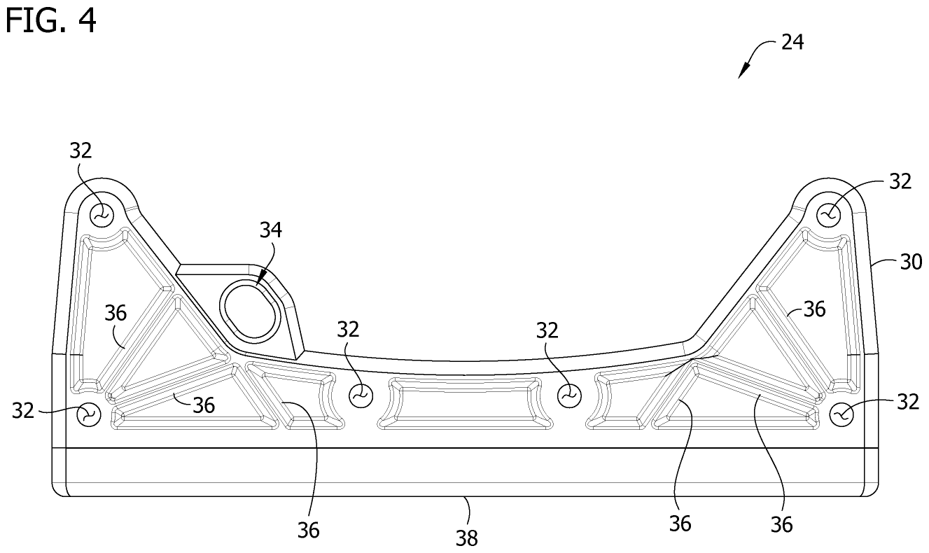

Referring to FIGS. 1-6, the reference 22 and the end wall 24 each include a body 30 (e.g., reference body, wall body). The body 30 can be formed of metal or plastic. For example, the body 30 can be formed by injection molding. The body 30 is generally planar. Each body 30 includes a plurality of fastener openings 32 for receiving fasteners 42 (e.g., bolts, screws, nails, etc.) that connect the body to the object support 14. The fasteners 42 are received in corresponding channels or openings of the object support 14. Other ways of connecting the reference 22 and the end wall 24 to the object support 14 can be used without departing from the scope of the present disclosure. For example, alternatively or in addition to the fasteners 42, an adhesive (e.g., glue) can be used to connect the reference 22 and end wall 24 to the object support 14.

The measurement device 10 can include one or more tether attachment points or openings 34 for connecting a tether or cord (not shown). In the illustrated embodiment, the measurement device 10 includes two tether attachment points 34. The two tether attachment points 34 are disposed at opposite ends of the object support assembly 12. The reference 22 (e.g., body 30 thereof) includes or forms a first tether attachment point 34 and the end wall 24 includes or forms the second tether attachment point 34. The tether attachment points 34 are located adjacent the upper edge or end of the reference 22 and the end wall 24.

Each body 30 of the reference 22 and the end wall 24 can include one or more ribs 36 or other reinforcement structures for strengthening the body. The ribs 36 can be an integral part with the rest of the body 30. The ribs 36 extend along an exterior side of the body 30. As shown in FIGS. 2-4, some of the ribs 36 extend from the tether attachment point 34 to fastener openings 32, some of the ribs extend between fastener openings, some of the ribs extend from other ribs to the fastener openings, and some of the ribs extend between a perimeter ridge or lip extending around the perimeter of the body 30 to other points on the perimeter ridge or lip or to a fastener opening. The ribs 36 form a lattice or web-like structural framework across the body 30, extending between various mounting points and other locations to provide structural strength while minimizing material usage.

The object support assembly 12 can include one or more feet 38 that engage a support surface, such as to support the measurement device 10 on the support surface. The object support 14, the reference 22, and/or the end wall 24 can include (e.g., form) one or more feet 38 (broadly, each can have at least one foot), such as non-slip feet to inhibit the measurement device 10 from sliding on the support surface, such as a wet boat deck. The feet 38 may be formed out of an elastomeric material (e.g., rubber, silicone, TPE, etc.). In one embodiment, the feet 38 are formed by overmolding. The feet 38 can have non-slip surfaces to provide grip, such as to inhibit the measuring device 10 from sliding on a wet support surface (e.g., a wet boat deck). The softer elastomeric material of the feet 38 can also dampen sound when placing the measurement device 10 on the support surface.

In the illustrated embodiment, the reference 22 includes one foot 38 and the end wall 24 includes another foot 38. The object support 14 does not include a foot. In one embodiment, the material forming each foot 38 is over-molded onto the body 30 of the reference 22 and the end wall 24. Each foot 38 forms the lower end or edge of the reference 22 and end wall 24, respectively. The feet 36 are disposed (e.g., extend) below the bottom of the object support 14. This spaces the bottom of the object support 14 from the support surface, providing a more stable arrangement. For example, if the support surface is curved (e.g., like a surface of a kayak), a measurement device with a flat bottom and no feet can easily rock and wobble on the curved support surface. In contrast, the feet 38 of measurement device 10 space the bottom of the object support 14 away from the curved support surface. Other configurations (e.g., including feet on the object support) can be used without departing from the scope of the present disclosure.

The reference 22 can include a pad or bumper 40 at an upper end thereof (e.g., forming the upper end or edge of the reference). The bumper 40 can be similar to the feet 38 and serves a similar purpose. The bumper 40 can be formed out of an elastomeric material (e.g., rubber, silicone, TPE, etc.). In one embodiment, the material forming the bumper 40 is over-molded onto the body 30 of the reference 22. The bumper 40 can provide acoustic damping and/or grip, such as when placing the measuring device 10 against a surface, such as a deck or gunnel of a boat (e.g., kayak).

The reference 22 (e.g., bump wall) includes a contact surface that faces toward the second end of the object support 14. The contact surface is planar and is perpendicular to the axis of the object support 14. The user engages the end of the object with the contact surface when measuring the length of the object. In one embodiment, the contact surface or at least a portion thereof can include a visually reflective area 44 which visually reflects the object (broadly, the contact surface can be a visually reflective contact surface). This allows a user or other person to confirm the end of the object is indeed in contact with the reference 22 (e.g., contact surface) when determining the length of the object. When a person sees the end of the object touching the end of the object in the reflection from the visually reflective area 44, the person knows the end of the object is in contact with the reference 22. If a photograph is taken of the object being weighed (such as a photograph submitted in a fishing tournament to verify a length of a fish), a person can use the visually reflective area 44 to confirm when looking at the photograph that the end of the object (e.g., nose of the fish) is in contact with the reference 22, confirming an accurate length measurement from the ruler 26. The visually reflective area 44 can be formed by a mirror mounted to the body 30, by a sticker (having a reflective surface) applied to the surface of the body, by polishing the contact surface of the body to become reflective (such as when the contact surface is made of metal), or by any other suitable means. In other embodiments, the visually reflective area 44 is omitted from the reference 22.

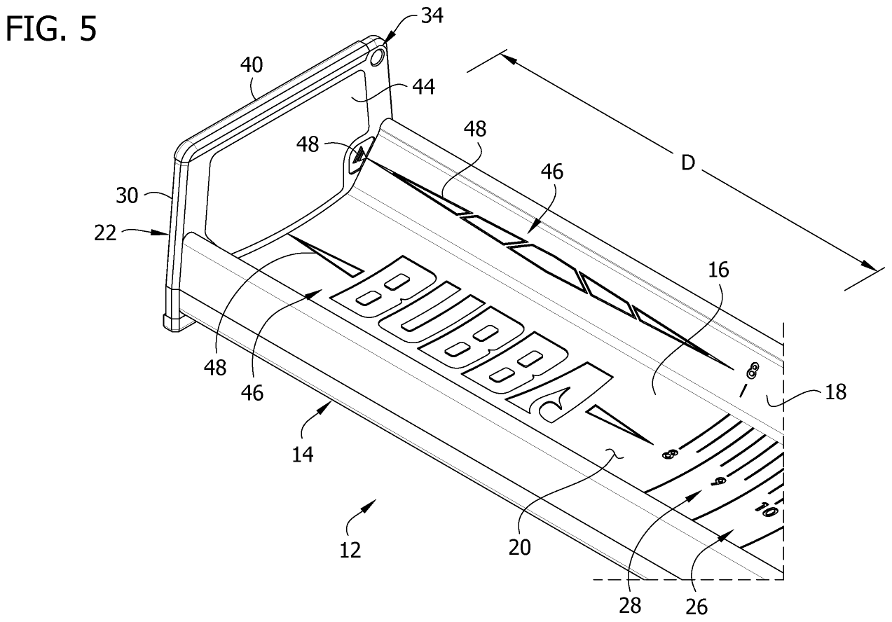

Referring to FIGS. 1 and 5, the measuring device 10 can include one or more anti-tamper features 46 to visually indicate if the measuring device 10 has been altered (e.g., a length thereof has been altered). In particular, the anti-tamper features 46 visually indicate if a length L of the object support 14 has been altered. More specifically, the anti-tamper features 46 visually indicate if the distance D between the start of the 26 (the start of the ruler indicia 28 (e.g., the ruler indicia associated with “8” as illustrated)) and the reference 22 (broadly, a location of the measuring indicia relative to the reference) has been altered.

A person may attempt to remove a portion of the object support 14 between the reference 22 and the start of the ruler 26 to bring the start of the ruler closer to the reference (after reconstructing the measuring device 10), to have the ruler indicate a length (e.g., length value) of the object that is greater (e.g., an untrue or false length) than the actual length of the object. One way a cheater can reduce the distance D between the reference 22 and the start of the ruler 26 is by disconnecting the reference from the first end of the object support 14, cutting off an end portion of the object support and then reattaching the reference to the new end of the object support. Another way a cheater can reduce the distance D between the reference 22 and the start of the ruler 26 is by cutting the object support 14 crosswise (e.g., generally perpendicular to the axis) in two places between the reference and the start of the ruler 26, removing the section of the object support between the two cuts and then rejoining the remaining portions of the object support together.

By modifying the measuring device 10 in this manner, a person can cheat in a fishing tournament by having their measuring device 10 indicate a length of a fish that is greater than the actual length of the fish. Because fish can be released after being caught (even in fishing tournaments), a picture of the fish on the measuring device 10 can be the only evidence submitted to establish the length of a caught fish. The anti-tamper features 46 allow a person (e.g., judge) looking at the measuring device 10, even in a photo of the measuring device with an object (e.g., fish) thereon, to visually confirm the measuring device 10 (e.g., the length of the object support 14) has not been altered. Like the ruler 26, the anti-tamper features 46 are arranged to be viewed by a user or person looking generally downward at the measuring device 10 from above.

The one or more anti-tamper features 46 include anti-tamper indicia 48 having a visual appearance that would be altered if a portion of the object support 14 is removed, making it visually evident if the length of the object support 14 has been altered (e.g., reduced). The object support 14 includes at least one anti-tamper indicia 48 (broadly, anti-tamper feature 46). The at least one anti-tamper indicia 48 of the object support 14 is disposed between the reference 22 and the start of the ruler 26. The object support 14 can include an anti-tamper indicia 48 on the support surface 16 and/or on one or both of the side surfaces 18. In the illustrated embodiment, the object support 14 includes a first or side anti-tamper indicia 48 on one of the side surfaces 18 and a second or bottom anti-tamper indicia 48 on the support surface 16. In one embodiment, the object support can include a third anti-tamper indicia on the other side surface that is a mirror image of the first anti-tamper indicia. Having anti-tamper indicia 48 on one or both of the side surfaces 18 makes such anti-tamper indicia more likely to be visible in a photograph taken with an object on the measuring device 10 (the object likely obscuring the anti-tamper indicia on the support surface 16), allowing a person (such as a tournament official) to validate the measuring device 10 used in the photograph and confirm that the measuring device 10 (e.g., the length of object support 14) has not been altered.

The anti-tamper indicia 48 of the object support 14 are each arranged relative to the reference 22 such that a visual appearance of the anti-tamper indicia 48 will be altered if a portion of the object support 14 adjacent the reference 22 is removed to alter the length of the object support 14. Desirably, the anti-tamper indicia 48 of the object support 14 extends near the reference 22, and more desirably, over the entire distance or nearly the entire distance between the reference 22 and the start of the ruler 26 to ensure at least some portion of the anti-tamper indicia 48 will be altered (e.g., defaced, deformed, removed, etc.) if a portion of the object support between the reference and the ruler is removed. The anti-tamper indicia 48 can touch or nearly touch the reference 22 and/or the ruler 26 (e.g., the start of the ruler indicia 28). As used herein and in the claims, the phrase “nearly touch” means a distance between the two elements is about ¼-inch or less. For example, the anti-tamper indicia 48 nearly touching the ruler 26 means a distance between the anti-tamper indicia 48 (e.g., the end thereof) and the ruler 26 is about ¼-inch or less. In the illustrated embodiment, each anti-tamper indicia 48 of the object support 14 touches the reference 22 and nearly touches the ruler 26. In other embodiments, anti-tamper indicia nearly touches the reference and nearly touches the ruler, or touches the reference and touches the ruler, or nearly touches the reference and touches the ruler.

The anti-tamper indicia 48 can be any suitable indicia, such as a design, logo, word, number(s), letter(s), etc. In the illustrated embodiment, the anti-tamper indicia 48 on the side surface 18 is an elongate arrow (e.g., double arrow) design. The anti-tamper indicia 48 on the support surface 16 includes a logo (in the form of a brand name—e.g., “Bubba”) with two arrows on either side of the logo extending in opposite directions. Other configurations of the anti-tamper indicia can be used without departing from the scope of the present disclosure. Desirably, the anti-tamper indicia 48 is not part of the ruler 26 (e.g., does not provide a length of the object or more specifically is not ruler indicia). For example, the illustrated anti-tamper indicia 48 does not visually indicate a value (e.g., 8-inches) of the length of the object.

The anti-tamper indicia 48 is a fixed part of the object support 14. The anti-tamper indicia 48 can be an integral part of the object support 14 (e.g., injection molded with the object support, laser etched on the object support, etc.) or can be added to the object support (e.g., painted on the object support, etc.).

The measuring device 10 can also include an anti-tampering feature 46 on the reference 22. The anti-tampering feature 46 on the reference 22 includes anti-tamper indicia 48 (e.g., third or reference anti-tamper indicia). The reference anti-tamper indicia 48 visually aligns with at least one of the anti-tamper indicia 48 of the object support 14. The reference anti-tamper indicia 48 and the at least one of the anti-tamper indicia 48 of the object support 14 align with or meet one another at an intersection of the reference 22 and the object support 14. The alignment of these anti-tamper indicia 48 can be easily identified by a person (such as a tournament official), either in-person or via a photograph. Any alteration to the length of the object support 14 (such as by cutting off a section of the object support 14 adjacent the reference 22 to move the ruler indicia 28 closer to the reference) would result in theses anti-tamper indicia 48 no longer meeting, thereby making it visually evident that the measuring device 10 has been tampered with (e.g., the length of the object support 14 has been altered).

In the illustrated embodiment, the reference anti-tamper indicia 48 aligns with the anti-tamper indicia 48 on the side surface 18 of the object support. The arrow of the anti-tamper indicia 48 on the side surface 18 points at the reference anti-tamper indicia. The reference anti-tamper indicia 48 is also an arrow that points at the anti-tamper indicia 48 on the side surface 18. As illustrated, the points of these two arrows touch at the intersection of the reference 22 and the object support 14. If an end portion of the object support 14 adjacent the reference 22 is removed, part of the arrow of the anti-tamper indicia 48 on the side surface 16 would be removed, and the points of the arrows would no longer meet, thereby indicating the object support has been tampered with.

In embodiments where the object support include an anti-tamper indicia on both side surfaces, the reference can include a second reference anti-tamper indicia (generally identical to the other reference anti-tamper indicia) for alignment with the anti-tamper indicia on the other side surface of the object support.

The reference anti-tamper indicia 48 is a fixed part of the reference 22. The reference anti-tamper indicia 48 can be an integral part of the reference 22 (e.g., injection molded with the body 30 of the reference, laser etched on the body, etc.) or can be added to the reference (e.g., painted on the body, etc.).

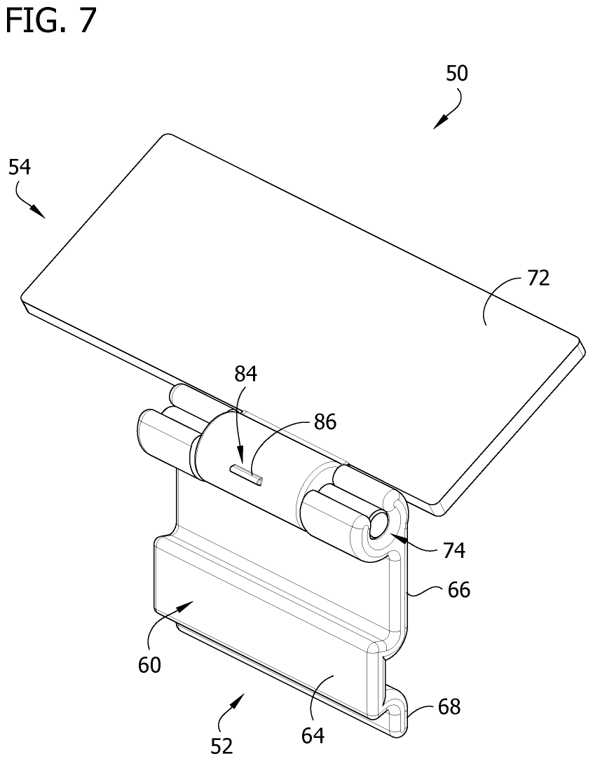

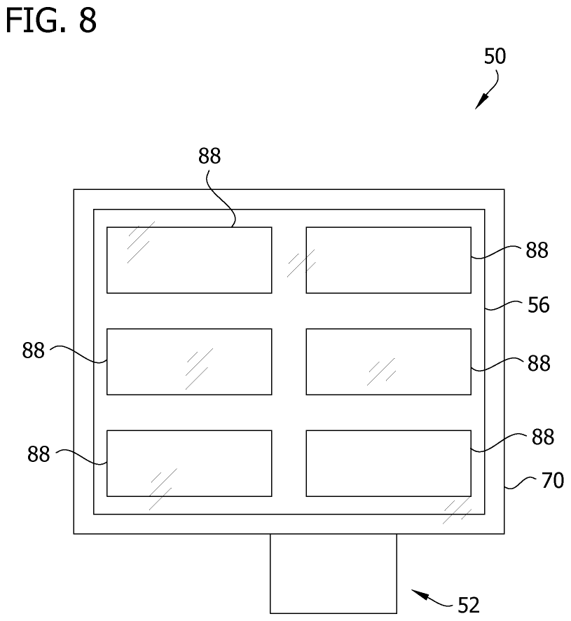

Referring to FIGS. 1, 2, and 6-8, the measuring device 10 can include an identification holder 50 (e.g., card or badge holder) for supporting an identifier 56 (e.g., badge, card, etc.), such as a tournament badge or identification (ID) card or badge. The identification holder 50 allows a user to attach the identifier 56 to the measuring device 10. The identification holder 50 is supported by (specifically, connected to) and moveable along the object support 14. This allows the user to position the identifier 56 at any position along the length L of the object support 14.

The identification holder 50 includes a slide 52 and a mount 54. The mount 54 supports the identifier 56. The slide 52 slideably connects to the object support 14 (the slide slideably or moveably connects the identification holder 50 to the object support). The slide 52 allows the identification holder 50 to be positioned at any position along the length L of the object support 14, such as to position the identifier in view of a camera when a photograph of the object (e.g., fish) on the measuring device 10 is taken. The object support 14 has an exterior side 58. The identification holder 50 includes a connector 60 connecting the identification holder to the exterior side 58 of the object support 14. The connector 60 is part of the slide 52. In the illustrated embodiment, the exterior side 58 of the object support 14 includes a channel 62 (e.g., track) that receives the connector 60 (broadly, the slide 52). The connector 60 is disposed in and slideable along the channel 62. This permits the slide 52 (broadly, the identification holder 50 and identifier 56) to move along the length of the channel 62, and thereby the length L of the object support 14. In the illustrated embodiment, the channel 62 has a dovetail cross-sectional shape and the connector 60 comprises a dovetail projection or key 64 having a dovetail cross-sectional shape that corresponds to the dovetail shape of the channel. The dovetail projection 64 fits within the channel 62 and permits the slide 52 to move along the channel. The slide 52 can have an upper wall 66 and/or lower wall 68 engage corresponding exterior surfaces of the object support 14 on the exterior side 58 to stabilize the slide (broadly, the bade holder 50) relative to the object support.

The object support 50 can include one or more stops to prevent the slide 52 (specifically, the connector 60) from sliding out of one or both ends of the channel 62. In the illustrated embodiment, the stops are formed by the reference 22 and the end wall 24. The reference 22 blocks or closes one end of the channel 62 and the end wall 24 blocks or closes the other end of the channel to inhibit the slide 52 from moving out of either end of the channel.

In the illustrated embodiment, the identification holder 50 (specifically, the slide 52) does not underlie the object support 14. The identification holder 50 (specifically, the slide) does not underlie the support surface 16. The identification holder 50 (specifically, the slide) does not extend from one exterior side of the object support 14 to the other exterior side of the object support. The identification holder 50 (specifically, the slide 52) is disposed entirely outside of the object receiving channel 20. This configuration arranges the identification holder 50 (specifically, the slide 52) such that the identification holder can move along the length L of the object support 14 without interference from the object on the object support 14 and/or from the support surface (e.g., boat deck) or any other item underlying the object support. This makes it easier to change the position of the identification holder 50 and identifier 56, such as when taking a photograph. In the illustrated embodiment, the exterior side 58 of the object support 14 that includes the channel 62 is the exterior side adjacent to the side surface 18 that includes the anti-tamper indicia 48. This arrangement results in the anti-tamper indicia 48 on the side surface 18 and the identifier 56 held by the identification holder 50 both being in view of the camera taking the photograph. Other configurations can be used without departing from the scope of the present disclosure.

The mount 54 couples the identifier 56 to the identification holder 50. In the illustrated embodiment, the identification holder 50 includes a sheath or sleeve 70 (e.g., card or badge sheath or sleeve) for receiving the identifier 56. The sheath 70 (broadly, identifier receiver or connector) can be transparent, have a window or otherwise be configured to permit visual reading of information contained on the face of the identifier 56. The mount 54 includes a connector 72 for connecting the sheath 70 to the mount. The connector 72 can releaseably connect the sheath 70 to the mount 54. The connector 72 can be a magnet, corresponding hook and loop fastener portions, a snap, or any other suitable connector for releaseably connecting the sheath 70 to the mount 54. In other embodiments, the connector comprises an adhesive, which may permanently connect the sheath to the mount 54. Other ways of coupling the identifier to the mount can be used without departing from the scope of the present disclosure. For example, the identifier can be coupled directly to the mount, such as with adhesive.

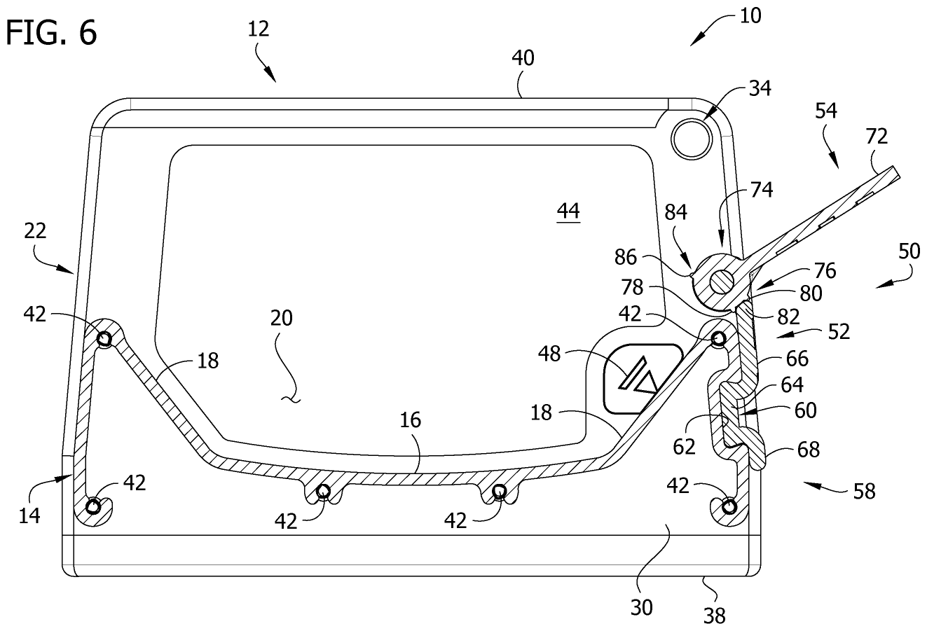

In the illustrated embodiment, the mount 54 (broadly, identifier 56) is moveable or pivotable between a first or stowed position (FIG. 2) and a second or operational position (FIG. 6). In the stowed position, the mount 54 can extend alongside the side surface 18 of the object support 14 into the object receiving channel 20 (e.g., a first stowed position). If the identifier 56 and/or sheath 70 is attached to the mount 54, the identifier 56/sheath 70 can be disposed in the object receiving channel 20 in the stowed position (e.g., the first stowed position), or can overlie the top of the object support 14 (overlie the top of the object receiving channel) if the identifier and/or sheath are too large to fit in the object receiving channel (e.g., a second stowed position). In the operational position, the mount 54 is arranged such that information on the identifier can be viewed. The mount 54 is connected to the slide 52 by a pivot connection or hinge 74. In the illustrated embodiment, the pivot connection 74 is formed by a shaft extending out either side of an opening in the mount. The shaft can be frictionally retained or otherwise secured in the opening of the mount. The slide 52 includes a shaft receiver having two spaced apart C-shaped arms that receive the opposite end portions of the shaft. The C-shaped arms are resiliently deflectable to permit the shaft to be inserted into the arms. The arms permit the shaft to rotate. Other configurations of the pivot connection can be used without departing from the scope of the present disclosure. The mount 54 pivots about the pivot connection 74 between the stowed and operational positions to position the identifier 56 relative to a camera (e.g., of a smart phone or other smart device) in order for the identifier to be viewable in a photograph of the object (e.g., fish) on the measuring device 10.

The identification holder 50 includes at least one retainer to keep the mount 54 (broadly, identifier 56) in at least one of the stowed position or the operational position. In the illustrated embodiment, the identification holder 50 includes retainers to keep or hold the mount 54 in both the stowed position and the operational position. The identification holder 50 includes a first or operational retainer 76. The operational retainer 76 keeps or holds the mount 54 in the operational position. In the illustrated embodiment, the operational retainer 76 is carried by and pivotable with the mount 54 about the pivot connection 74. The operational retainer 76 engages the slide 52 to maintain the mount 54 in the operational position. The operational retainer 76 includes first and second detents or projections 78, 80 that are spaced apart to receive an upper edge or keeper 82 of the slide 52 therebetween. The detents 78, 80 engage the keeper 82 to prevent the mount 54 from rotating in either direction (e.g., clockwise or counterclockwise) about the pivot connection (e.g., each detent prevents rotation in one direction). The detents 78, 80 and/or keeper 82 (along with the C-shaped arms and/or shaft) can be resiliently deformable (e.g., compressible) to permit the detents 78, 80 to move past the keeper 82 upon a sufficient application of manual force to move the mount between the stowed and operational positions.

The identification holder 50 includes a first or stowed retainer 84. The stowed retainer 84 keeps or holds the mount 54 in the stowed position. In the illustrated embodiment, the stowed retainer 84 is carried by and pivotable with the mount 54 about the pivot connection 74. The stowed retainer 84 engages the slide 52 to maintain the mount 54 in the operational position. The stowed retainer 84 includes a detent or projection 86 that engages the upper edge or keeper 82 of the slide 52. The detent 86 engages the keeper 82 to prevent the mount 54 from rotating from the stowed position toward the operational position. When the mount 54 is in the stowed position, the detent 86 can be positioned against the keeper 82, like the second detent 80 is in the operational position (see FIG. 6—the mount rotated such that the identifier 56/sheath 70 overlie the object support 14), or spaced apart from the keeper (see FIG. 2—the mount is rotated to contact the side surface 28). The detent 86 (along with the keeper 82, C-shaped arms and/or shaft) can be resiliently deformable (e.g., compressible) to permit the detent 86 to move past the keeper 82 upon a sufficient application of manual force to move the mount toward the operational position. Retainers of other configurations can be used without departing from the scope of the present disclosure.

Other configurations of the identification holder can be used without departing from the scope of the present disclosure.

The identifier 56 can be a piece of paper or cardboard, or a more rigid material such as plastic or metal. In the illustrated embodiment, the identifier 56 includes a plurality of designated marking areas or sections 88 for information (e.g., tournament information, such as name, code, identifier, date, etc.) to be written. In one embodiment, the designated marking areas are defined dry-writing material (e.g., acrylic) for nonpermanent writing that can be subsequently erased. Other configurations of the identifier can be used without departing from the scope of the present disclosure.

It is appreciated that the person of ordinary skill in the art is readily able to determine the scope of terms of degree such as, but not limited to, “about,” “substantially,” and “generally.” For example, when a term of degree is used in relation to a numeric value, the person of ordinary skill in the art understands that the term of degree covers an inclusive range of plus or minus 10% of the numeric value, unless clearly indicated or stated otherwise.

When introducing elements of the present disclosure or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

Modifications and variations of the disclosed embodiments are possible without departing from the scope of the disclosure defined in the appended claims. For example, where specific dimensions are given, it will be understood that they are exemplary only and other dimensions are possible. As various changes could be made in the above constructions, products, and methods without departing from the scope of the disclosure, it is intended that all matter contained in the above description and shown in the accompanying drawings shall be interpreted as illustrative and not in a limiting sense.

What is claimed is:

1. A measuring device for measuring a length of an object, the measuring device comprising:
an object support having a support surface configured to receive and support the object thereon, the object support having ruler indicia extending along the support surface;
a reference coupled to the object support, the reference arranged to be contacted by one end of the object when the object is on the support surface of the object support, the ruler indicia of the object support indicating distance from the reference; and
an anti-tamper feature configured to visually indicate if a length of the object support has been altered.

2. The measuring device of claim 1, wherein the anti-tamper feature is configured to visually indicate if a distance between a start of the ruler indicia and the reference has been altered.

3. The measuring device of claim 2, wherein the distance between the reference and the start of the ruler indicia is greater than or equal to 1 inch.

4. The measuring device of claim 3, wherein the distance between the reference and the start of the ruler indicia is greater than or equal to 5 inches.

5. The measuring device of claim 4, wherein the distance between the reference and the start of the ruler indicia is greater than or equal to 8 inches.

6. The measuring device of claim 1, wherein the anti-tamper feature includes a first anti-tamper indicia on the object support, the first anti-tamper indicia arranged relative to the reference such that a visual appearance of the first anti-tamper indicia will be altered if a portion of the object support adjacent the reference is removed to alter the length of the object support.

7. The measuring device of claim 6, wherein the first anti-tamper indicia touches or nearly touches the reference.

8. The measuring device of claim 6, wherein the anti-tamper feature includes a second anti-tamper indicia on the reference, the first and second anti-tamper indicia visually aligned with one another.

9. The measuring device of claim 8, wherein the first anti-tamper indicia comprises an arrow pointing at the second anti-tamper indicia.

10. The measuring device of claim 1, wherein the anti-tamper feature does not visually indicate a value of the length of the object.

11. A measuring device for measuring a length of an object, the measuring device comprising:
an object support having a support surface configured to receive and support the object thereon, the object support having ruler indicia extending along the support surface;
a reference coupled to the object support, the reference arranged to be contacted by one end of the object when the object is on the support surface of the object support, the ruler indicia of the object support indicating distance from the reference; and
an identification holder configured to support an identifier, the identification holder being supported by and moveable along the object support.

12. The measuring device of claim 11, wherein the object support having an exterior side, and wherein the identification holder includes a connector connecting the identification holder to the exterior side of the object support.

13. The measuring device of claim 12, wherein the exterior side of the object support includes a channel, the connector of the identification holder being disposed in and slideable along the channel.

14. The measuring device of claim 11, wherein the identification holder does not underlie the object support.

15. The measuring device of claim 11, wherein the identification holder does not underlie the support surface.

16. The measuring device of claim 11, wherein the object support defines an object receiving channel, wherein the identification holder is disposed entirely outside of the object receiving channel.

17. The measuring device of claim 11, wherein the object support defines an object receiving channel, wherein the identification holder includes a slide being slideably connected to the object support and a mount for coupling the identifier to the identification holder, the slide being disposed entirely outside of the object receiving channel.

18. The measuring device of claim 11, wherein the identification holder includes a mount for supporting the identifier, the mount being pivotable between a first position and a second position where the mount is arranged such that information on the identifier can be viewed.

19. The measuring device of claim 17, further comprising at least one retainer configured to keep the mount in at least one of the first position or the second position.

20. The measuring device of claim 18, wherein the at least one retainer comprises a first retainer and a second retainer, the first retainer configured to keep the mount in the first position, and the second retainer configured to keep the mount in the second position.
